(19) United States
(12) Patent Application Publication
(10) Pub. No.: US 2007/0098398 A1
(43) Pub. Date: May 3, 2007

(54) Image taking apparatus

(75) Inventors: Tatsuhiko Hagiwara, Asaka (JP); Naoyuki Nishikawa, Minami-Ashigara (JP); Kazuhiko Onda, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/590,273

(22) Filed: Nov. 1, 2006

(30) Foreign Application Priority Data
Nov. 1, 2005 (JP) 2005-318614

(51) Int. Cl. G03B 9/02

(52) U.S. Cl. 396/505

(57) ABSTRACT

An imaging apparatus includes a light quantity control mechanism that diaphragms object light quantity entering into an image taking optical system to transmit to an imaging area of an imaging device. The light quantity control mechanism includes a base plate that has an aperture on an optical axis of the image taking optical system, and a light quantity control plate that is composed of plural of diaphragm blades which are arranged to overlap the base plate, and which varies an area of an aperture covering the aperture of the base plate, responding to an electrical field formed by an applied voltage.

### BACKGROUND OF THE INVENTION

1. Field of the Invention

The present invention relates to an image taking apparatus. The image taking apparatus includes an imaging device which reads an object image formed on an imaging area to generate image data, and an image taking optical system which images an object on the imaging area to generate image data responding to an operation.

2. Description of the Related Art

So-called digital cameras have come into wide use recent years. A digital camera captures object light entering through an image taking lens, with an imaging device to generate an image signal. A digital camera is provided with components such as a diaphragm to control object light quantity responding to conditions such as brightness of a place to be shot, and a shutter to limit time period while the imaging area is exposed to object light. A driving source such as a motor is used to drive a diaphragm or a shutter (for example, Japanese patent Laid-open No. H07-191378, FIG. 1, pp. 7.)

According to the technique disclosed in Japanese patent Laid-open No. H07-191378, the blade-shaped member used for the shutter is so devised as to suppress power consumption by the motor as a driving source.

Some digital cameras have motion picture taking function. Those cameras generally records motion picture data together with audio data.

Mechanical operation noises of a driving source to drive a shutter or diaphragm may be recorded through a microphone mounted on the camera while taking a motion picture.

For example, when the shutter disclosed in Japanese patent Laid-open No. H07-191378 is applied to a digital camera having motion picture taking function, motor operation noises may be recorded through the microphone even though power consumption of the motor as a driving source is saved.

In other words, because mechanical operation noises of a driving source are unnecessary for a user, it is desirable to reduce noises.

In addition, digital camera miniaturization has been progressed recent years. In this situation, there is a problem that driving sources such as a motor to drive a diaphragm and a shutter generally require large space.

### SUMMARY OF THE INVENTION

The present invention has been made in view of the above-mentioned circumstances and provides an image taking apparatus which includes a light quantity controlling capability with noise reducing capability installed, and which is simultaneously miniaturized.

A first image taking apparatus according to the invention is exemplified as follows. An image taking apparatus which includes an imaging device reading an object image formed on an imaging area to generate image data and an image taking optical system imaging an object on the imaging area, and generates image data responding to an image taking operation, the image taking apparatus including:

a light quantity control mechanism which regulates quantity of object light to transmit to the imaging area, the object light entering into the image taking optical system,

the light quantity control mechanism further comprising:

a base plate which has an aperture on an optical axis of the image taking optical system; and

a light quantity control plate which is arranged to overlap the base plate, and which expands and contracts responding to an electrical field formed by an applied voltage, thereby varying an area covering the aperture of the base plate.

According to the first image taking apparatus, because the light quantity control mechanism, in which the light quantity control plate expands and contracts responding to an electrical field to control object light quantity, is applied, an image taking apparatus which includes capabilities such as a diaphragm and shutter is provided without using a mechanism which is driven by driving source such as a motor used for driving a diaphragm and shutter. Therefore, because this light quantity control mechanism does not include a mechanism which produces noises by a driving source such as a motor which is used for a diaphragm and shutter, diaphragm and shutter which does not produce noises are provided. In addition, because space for a driving source such as a motor used for a diaphragm and shutter is saved, a miniaturized image taking apparatus is provided.

It is preferable that in the first image taking apparatus among the image taking apparatus according to the invention, the light quantity control plate is composed of a plurality of diaphragm blades which jointly form an aperture overlapping the aperture of the base plate, and which expand and contract responding to an electrical field, thereby varying an area of the aperture overlapping the aperture of the base plate.

In the first image taking apparatus, because the plural diaphragm blades expand and contract responding to an electrical field, it is not necessary to use an existing component which drives a diaphragm blade and it is possible to reduce number of parts to be used. Therefore, the image taking apparatus is miniaturized.

It is desirable that in the first image taking apparatus among the image taking apparatus according to the invention, the light quantity control plate further comprising:

a member made of a liquid crystal elastomer which expands and contracts responding to an electrical field; and

a pair of electrodes which are arranged to sandwich the member made of the liquid crystal elastomer, and which form an electrical field in the member made of the liquid crystal elastomer with a voltage applied, thereby expanding and contracting the member made of the liquid crystal elastomer.

In the first image taking apparatus, because a liquid crystal elastomer is used as the light quantity control plate which expands and contracts quickly responding to an electrical field, it is possible to control efficiently object light quantity.

It is desirable that in the first image taking apparatus among the image taking apparatus according to the invention, the light quantity control plates further comprising:

a member made of an electrostrictive polymer which expands and contracts responding to an electrical field; and a pair of electrodes which are arranged to sandwich the member made of the electrostrictive polymer, and which form an electrical field in the member made of the electrostrictive polymer with a voltage applied, thereby expanding and contracting the member made of the electrosrictive polymer.

In the first image taking apparatus, because an electrostrictive polymer is also used as the light quantity control plate which expands and contracts quickly responding to an electrical field, it is possible to control efficiently object light quantity.

A second image taking apparatus is exemplified as follows. An image taking apparatus which includes an imaging device reading an object image formed on an imaging area to generate image data and an image taking optical system imaging an object on the imaging area, and generates taken image data responding to an image taking operation, the image taking apparatus comprising:

a light quantity control mechanism which regulates quantity of object light to transmit to the imaging area, the object light entering into the image taking optical system, wherein

the light quantity control mechanism further comprising:

a base plate which has an aperture on an optical axis of the image taking optical system;

a light quantity control plate which moves to vary an area covering the aperture of the base plate; and

a driving plate which expands and contracts responding to an electrical field formed by an applied voltage, thereby moving the light quantity control plate.

In the second image taking apparatus, because a light quantity control mechanism, in which a driving plate expands and contracts responding to an electrical field to move a light quantity control plate to control object light quantity, is applied, an image taking apparatus which includes capabilities such as a diaphragm and shutter is provided without using a mechanism which is driven by a driving source such as a motor used for driving a diaphragm and shutter, similarly to the first image taking apparatus. Therefore, because the light quantity control mechanism does not include a mechanism which produces noises by a driving source such as a motor which is used for a diaphragm and shutter, a diaphragm and a shutter which does not produce noises are provided. In addition, because space for a driving source such as a motor used for a diaphragm and shutter is saved, a miniaturized image taking apparatus is provided.

It is preferable that in the second image taking apparatus, the light quantity control plate is a diaphragm member which has an aperture and is driven by the driving plate to move between a small aperture position where the aperture overlaps the aperture of the base plate and a saved position where the light quantity control plate is saved from the aperture of the base plate.

In the second image taking apparatus, it is possible to adjust precisely light quantity going through the aperture of the base plate.

It is desirable that in the second image taking apparatus among the image taking apparatus according to the invention, the light quantity control plate is a diaphragm member which is arranged to overlap the base plate and which is driven by the driving plate, thereby moving to vary an area covering the aperture of the base plate.

In the second image taking apparatus, by applying such a diaphragm member, it is possible to control light quantity without using plural diaphragm blades.

It is desirable that in the second image taking apparatus among the image taking apparatus according to the invention, the light quantity control plate is composed of a plurality of diaphragm blades which jointly form an aperture overlapping the aperture of the base plate, and which is driven by the driving plate, thereby varying an area of the aperture overlapping the aperture of the base plate.

In the second image taking apparatus, because plural diaphragm blades are used to allow adjusting a diaphragm aperture at plural levels, it is possible to enhance the degree of freedom to control light quantity.

It is desirable that in the second image taking apparatus among the image taking apparatus according to the invention, the driving plate further including:

a member made of a liquid crystal elastomer which expands and contracts responding to an electrical field; and

a pair of electrodes which are arranged to sandwich the member made of the liquid crystal elastomer, and which form an electrical field in the member made of the liquid crystal elastomer with a voltage applied, thereby expanding and contracting the member made of the liquid crystal elastomer.

In the second image taking apparatus, because a liquid crystal polymer is used to expand and contract quickly responding to an electrical field, it is possible to control efficiently object light quantity.

It is desirable that in the second image taking apparatus among the image taking apparatus according to the invention, the driving plate further including:

a member made of an electrostrictive polymer which expands and contracts responding to an electrical field, and which form an electrical field in the member made of the electrostrictive polymer with a voltage applied, thereby expanding and contracting the member made of the electrostrictive polymer.

With the second image taking apparatus, because an electrostrictive polymer is also used as the driving plate to expand and contract quickly responding to an electrical field, it is possible to control efficiently object light quantity.

According to the invention, an image taking apparatus which includes a light quantity controlling capability as well as noise reducing capability, and which is simultaneously miniaturized, is provided.

### BRIEF DESCRIPTION OF THE DRAWINGS

FIG. 1 is a diagram showing a fundamental principle of a light quantity control mechanism applied to an image taking apparatus according to the invention.

FIG. 2 is an external perspective diagram of a digital camera as a first embodiment of a first image taking apparatus.

FIG. 3 is an external perspective diagram of a digital camera of the first embodiment of the first image taking apparatus.

FIG. 4 is a perspective view a digital camera shown in FIG. 2 viewed from the above of its back.

FIG. 5 is a cross section showing a lens barrel collapsed in the digital camera of the first embodiment of the first image taking apparatus, when cut along an optical axis.

FIG. 6 is a cross section showing the lens barrel of the digital camera of the first embodiment of the first image taking apparatus with a back lens group in a wide-angled zoom, when cut along an optical axis.

FIG. 7 is a cross section showing the lens barrel of the digital camera of the first embodiment of the first image taking apparatus with the back lens group in a telephoto zoom, when cut along an optical axis.

FIG. 8 is a diagram showing a configuration of a light quantity control mechanism of the digital camera which is the first embodiment of the first image taking apparatus.

FIG. 9 is a schematic diagram showing an inner configuration of the digital camera shown in FIG. 2.

FIG. 10 is a diagram showing a light quantity control mechanism of a digital camera which is a second embodiment of the first image taking apparatus.

FIG. 11 is a diagram showing a light quantity control mechanism of a digital camera which is a first embodiment of a second image taking apparatus.

FIG. 12 is a diagram showing a light quantity control mechanism of a digital camera which is a second embodiment of the second image taking apparatus.

FIG. 13 is a diagram showing a light quantity control mechanism of a digital camera which is a third embodiment of the second image taking apparatus.

### DETAILED DESCRIPTION OF THE INVENTION

Exemplary embodiments of the invention will be described with reference to the accompanying drawings.

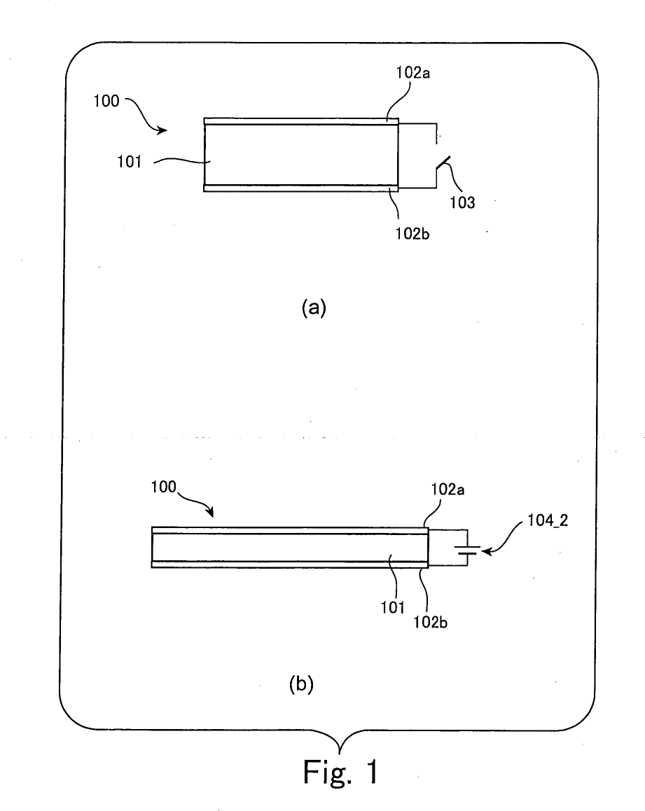

FIG. 1 is a diagram showing a fundamental principle of a light quantity control mechanism applied to an image taking apparatus according to the invention.

A light quantity control plate 100 shown in FIG. 1 has an elastic layer 101 which expands and contracts responding to an electrical field formed inside. An electrostrictive polymer is applied to the electrical layer 101.

The electrostrictive polymer is a polymer having a rubber elasticity to expand and contract responding to an electrical field. The elastic polymer 101 has shading quality.

The light quantity control plate 100 includes a pair of electrodes 102a and 102b which are affixed to the elastic layer 101 to expand and contract together with the elastic layer 101. The light quantity control plate 100 is processed for insulation to prevent a short circuit when they are overlaid each other.

As shown in part (a) of FIG. 1, the elastic layer 101 has a predetermined thickness at an initial state when a power switch 103 for applying an electrical field is turned off. As shown in part (c) of FIG. 1, when the power switch 103 is turned on, the light quantity control plate 100 is electrically connected to a power source 104_2. Then, an electrical field is formed between the electrode 102a and the electrode 102b. With an electrical field formed, the elastic layer 101 expands and the electrodes 102a and 102b also expand. In addition, when the power switch 103 is turned off after it is turned on, the light quantity control plate 100 returns to the initial state, as shown in part (a) of FIG. 1. Further, with the voltage controlled variably, the light quantity control plate 100 expands and contracts responding to an electrical field formed inside.

As described above, the electrostrictive polymer is applied to the elastic layer 101. However, a liquid crystal elastomer is also applied to obtain the same effect. The liquid crystal elastomer is also a polymer having rubber elasticity to expand and contract responding to an electrical field.

Next, a digital camera which is a first embodiment of a first image taking apparatus according to the invention will be described.

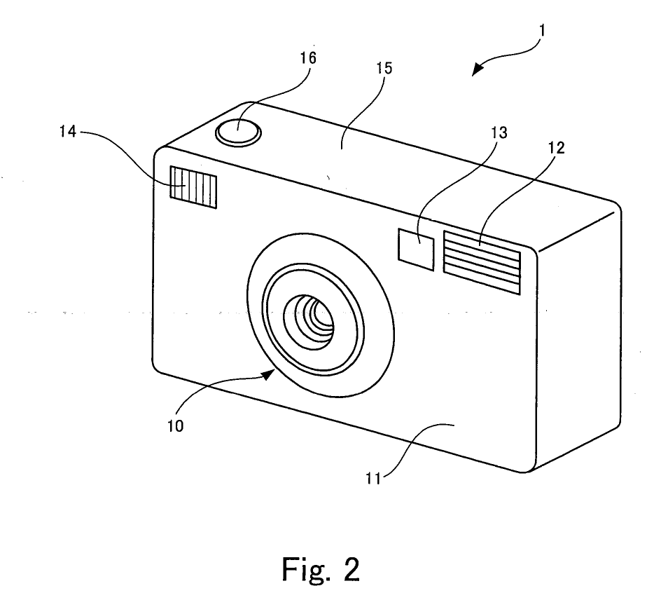

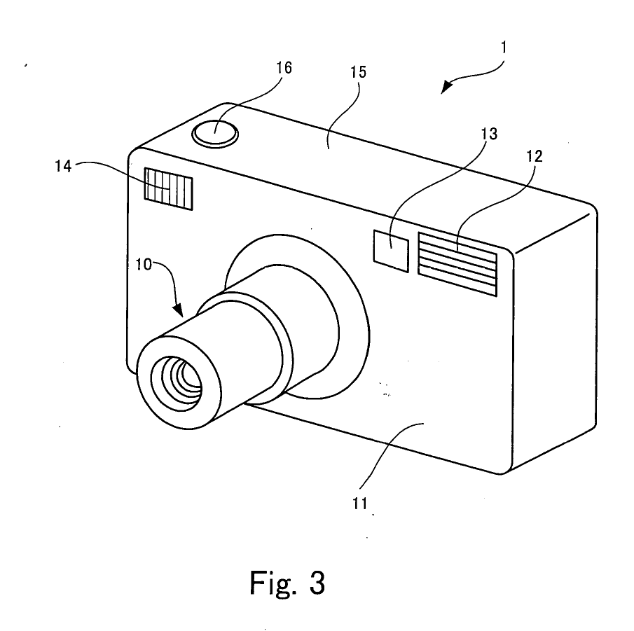

FIGS. 2 and 3 are both perspective views of the digital camera which is the first embodiment of the first image taking apparatus, as obliquely viewed from the above of its front.

FIGS. 2 shows a state where the lens barrel 10 including an image taking lens is collapsed in the digital camera 1. FIG. 3 shows a state where the lens barrel is extended.

On a front 11 of the digital camera 1 shown in FIGS. 2 and 3 are provided a flash window 12 through which a flash is transmitted toward an object, a finder object window 13 through which a user looks at an object, and a microphone 14 for recording sounds. On a top 15 is provided a release button 16.

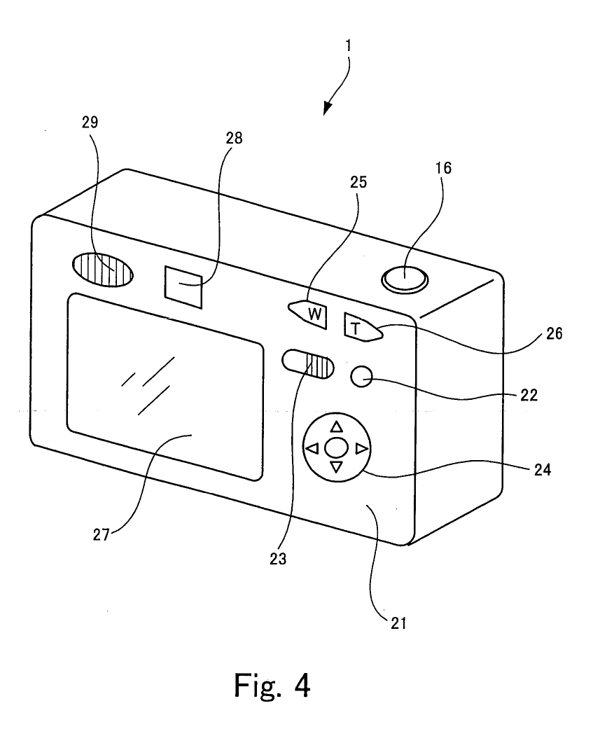

FIG. 4 is a perspective view of a digital camera shown in FIG. 2 as obliquely viewed from the above of its back.

As shown in FIG. 2, an a back 21 of the digital camera 1 is provided a power source button 22 and a mode switch 23. The power source button 22 is used for turning on and off power for the digital camera 1. The mode switch 23 is used for switching mode between an image taking mode and a replay mode.

On a back 21 of the digital camera 1 are provided a menu selection and execution key 24. The menu selection and execution key 24 is a key for changing menus freely to select a setting condition, the menus of still picture taking and motion picture taking in the image taking mode, and still picture replaying and motion picture replaying in the replay mode.

Further, on the back 21 of the digital camera 1 are provided a wide-angle zoom key 25, a telephoto zoom key 26, an LCD panel 27, an optical finder eyepiece window 28 and a speaker 29. The wide-angle zoom key 25 is a key for setting a focal length to a wide angle. The telephoto zoom key 26 is a key for setting a focal length to a telephoto angle. The LCD panel 27 is for displaying a picture of an object, the menus of the menus election and execution key 24 and others. The optical finder eyepiece window 28 is a window through which a user looks at an object to be taken an image of. The speaker 29 is for playing back sounds recorded by the microphone 14.

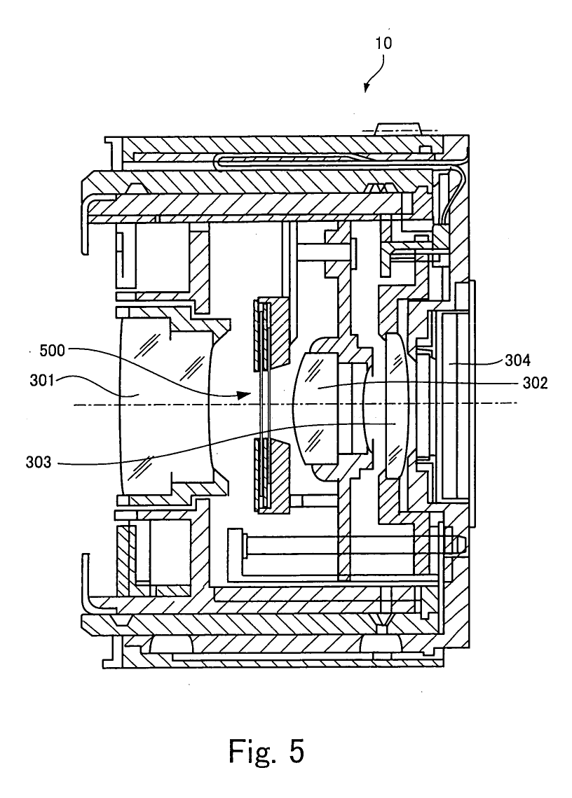

FIG. 5 is across section showing a lens barrel collapsed in the digital camera of the first embodiment of the first image taking apparatus, when cut along an optical axis.

In a space inside the lens barrel 10 is included a shooting lens in which three group lenses of a front group lens 301, a back group lens 302 and a focusing lens 303 are located in an order from the front to the back such that their optical axes are aligned. Behind the focusing lens 303 is provided a CCD 304 which reads object light to generate image data. The CCD 304 corresponds to an example of the imaging device according to the invention.

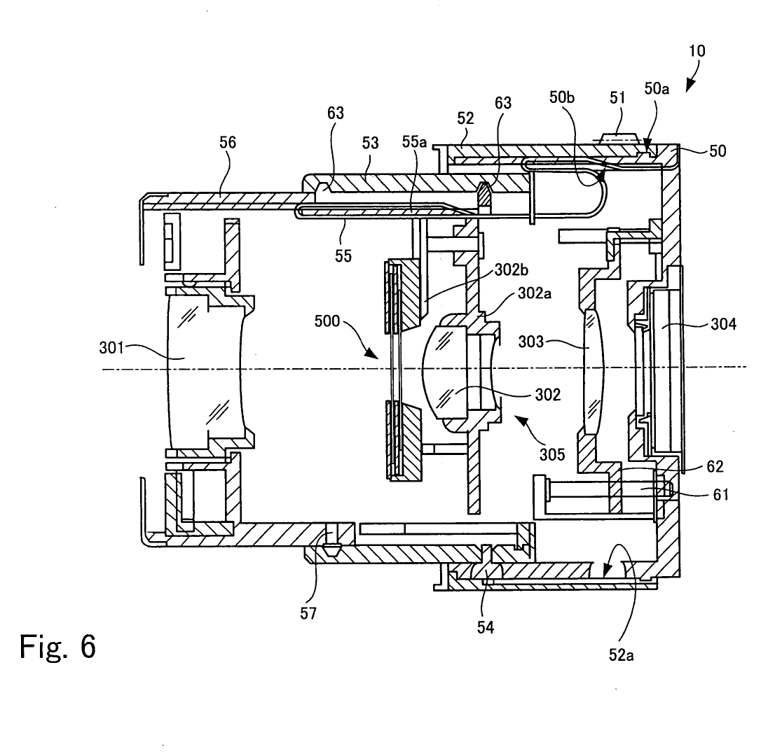

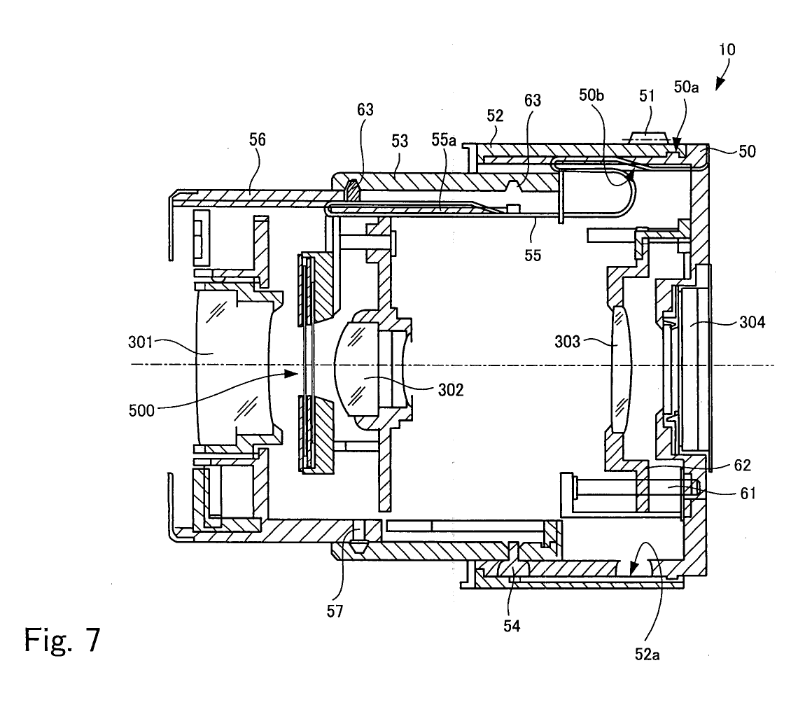

FIG. 6 is a cross section showing the lens barrel of the digital camera according to the embodiment of the first image taking apparatus, with a back group lens in a wide-angled zoom, when cut along an optical axis. FIG. 7 is a cross section showing the lens barrel of the digital camera of the embodiment of the first image taking apparatus with the back lens group in a telephoto zoom, when cut along an optical axis.

The shooting lens described above is configured such that the back group lens 302 moves along the optical axis between a wide angle end shown in FIG. 6 and a telephoto angle end shown in FIG. 7 to vary focal length, and the focusing lens 303 moves along the optical axis to adjust focus. Between the front group lens 301 and the back group lens 302 is provided a light quantity control mechanism 500. The light quantity control mechanism 500 will be described later in detail.

A fixed tube 50 and a driving tube 52 which rotates freely on the fixed tube 50 are provided in the lens barrel 10. Because a ridge 50a formed circumferentially on an outer wall of the fixed tube 50 is engaged in a groove formed on an inner circumferential surface of the driving tube 52, the driving tube 52 is restricted in moving in the direction of the optical axis against the fixed tube 50. A gear 51 is provided on an outer circumferential surface of the driving tube 52. Rotation driving force is transmitted to the gear 51 from a motor (not shown) to rotate the driving tube 52.

A keyway 52a extending in the direction of the optical axis is formed in the driving tube 52. A pin-shaped cam follower 54 fixed to a rotationally moving tube 53 goes through a spiral cam groove formed in the fixed tube 50 and is engaged in the keyway 52a. Accordingly, as the driving tube 52 rotates, the rotationally moving tube 53 rotates to move along the cam groove in the direction of the optical axis.

Inside the rotationally moving tube 53 is provided a rectilinear frame 55. The rectilinear frame 55 is engaged with the rotationally moving tube 53 so as to be rotatable on the rotationally moving tube 53, and in also engaged in the keyway 50b of the fixed tube 50 to be limited in rotation. Accordingly, as the rotationally moving tube 53 rotates to move in the direction of the optical axis according to rotation of the driving tube 52, the rectilinear frame 55 moves linearly in the direction of the optical axis according to movement of the rotationally moving tube 53.

A pin-shaped cam follower 63 is fixed to a back group lens holding frame 302a holding the back group lens 302 described above. Because the cam follower 63 is engaged in both a keyway of the rotationally moving tube 53 and a keyway 55a extending in the direction of the optical axis of the rectilinear frame 55, a back group lens 305 moves linearly along the keyway of the rotationally moving tube 53 as the rotationally moving tube 53 rotates to move in the direction of the optical axis according to rotation of the driving tube 52.

In addition, a rectilinear tube 56 holding the front group lens 301 is provided in the lens barrel 10. In the rectilinear tube 56, acam follower 57 fixed to the rectilinear tube 56 is engaged in both a cam groove of the rotationally moving tube 53 and the keyway 55a of the rectilinear frame 55. The keyway 55a extends in the direction of the optical axis. Accordingly, as the rotationally moving tube 53 rotates to move in the direction of the optical axis according to rotation of the driving tube 52, the rectilinear tube 56 moves linearly in the direction of the optical axis along the form of the cam groove of the rotationally moving tube 53, in which the cam follower 57 is engaged, according to rotation of the driving tube 52.

As described above, the lens barrel 10 is extended and the lens barrel 10 is collapsed as the driving tube 52 rotates in the opposite direction.

The rotationally moving tube 53 further rotates with a position of the front group lens 301 being maintained after the lens barrel 10 is finished extended. At this point, the back group lens unit 305 moves in the direction of the optical axis along the cam groove of the rotationally moving tube 53, and in this manner, view angle (that is, focal length) adjustment is performed.

Further, of the shooting lenses, the focusing lens 303 is adjusted to be focused as follows. As a lead screw 61 is rotated by a motor (not shown), the focusing lens 303 moves in the direction of the optical axis according to rotation of the lead screw 6 because a focusing lens holding frame 62 holding the focusing lens 303 is engaged in threads of the lead screw 61. Thereby focusing is performed.

Next, a light quantity control mechanism of the digital camera 1 which is the embodiment of the first image taking apparatus will be described.

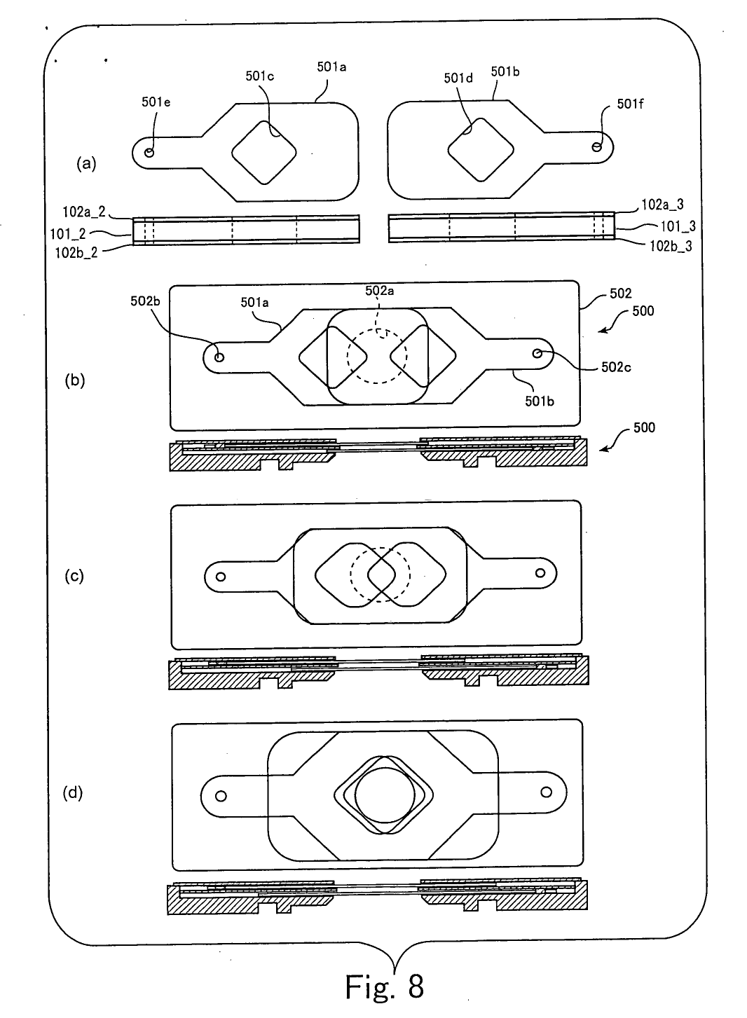

FIG. 8 is a diagram showing a configuration of a light quantity control mechanism of the digital camera which is the first embodiment of the first image taking apparatus.

Part (a) of FIG. 8 is a diagram showing a configuration of a first diaphragm blade and a second diaphragm blade.

Part (b) of FIG. 8 shows a front view and a cross section of the light quantity control mechanism.

The light quantity control mechanism 500 is composed of a base plate 502 having an aperture, a first diaphragm blade 501a and a second diaphragm blade 501b. The first diaphragm blade 501a and the second diaphragm blade 501b correspond to the light quantity control plate having shading quality shown in FIG. 1. The first diaphragm blade 501a is provided with electrodes 102a_2 and 102b_2 both sandwiching an elastic layer 101_2. The second diaphragm blade 501b is provided with electrodes 102a_3 and 102b_3 both sandwiching an elastic layer 101_3. Electrostrictive polymer is applied to the elastic layers 101_2 and 101_3. Thickness for each section of the first diaphragm blade 501a and the second diaphragm blade 501b appears large in the drawing for the sake of convenience, however, thickness of the blades is practically thin as shown in part (b) of FIG. 8.

Both of the first diaphragm blade 501a and the second diaphragm blade 501b are located on the base plate 502. The first diaphragm blade 501a is provided with an (diaphragm blade) aperture 501c and an aperture 501e, and is pinned on the base plate 502 with a fixing pin member 502b. The second diaphragm blade 501b is also provided with a diaphragm blade aperture 501d and an aperture 501f and is pinned on the base plate 502 with a fixing pin member 502c. The blades are fixed only with the fixing pin members 502b and 502c, so that the first diaphragm blades 501a and the second diaphragm blade 501b are able to expand and contract.

The first diaphragm blade 501a and the second diaphragm blade 501b overlay the aperture 502a of the base plate 502 and the diaphragm blade apertures 501c and 501d together form an aperture which overlays the aperture 502a of the base plate 502 to vary an area of the aperture which overlays the aperture 502a of the base plate 502 responding to an electrical field.

Part (b) of FIG. 8 is a diaphragm showing the position relation between the first diaphragm blade 501a and the second diaphragm blade 501b in an initial state. In part (b) of FIG. 8, any voltage is not applied and the aperture 502a of the base plate 502 is closed wholly.

Part (c) of FIG. 8 is a diaphragm showing the position relation between the first diaphragm blade 501a and the second diaphragm blade 501b after a predetermined voltage is applied with the power on.

The first diaphragm blade 501a and the second diaphragm blade 501b expand responding to an applied voltage and vary the area of the aperture overlaying the aperture 502a of the base plate. In part (c) of FIG. 8, the first diaphragm blade 501a and the second diaphragm blade 501b cover a portion of the aperture 502a.

Part (d) of FIG. 8 shows the position relation between the first diaphragm blade 501a and the second diaphragm blade 501b after a predetermined voltage is added further in the state shown in part (c) of FIG. 8.

The first diaphragm blade 501a and the second diaphragm blade 501b expand with a voltage applied, allowing the aperture 502a of the base plate to open wholly.

In the light quantity control mechanism 500, when the power is off, the aperture 502a of the base plate is closed by the first diaphragm blade 501a and the second diaphragm blade 501b. When the power is turned on, the aperture 502a of the base plate allows light to go through. Therefore, if the first light quantity control mechanism 500 is used for a diaphragm or a shutter, power consumption is saved.

Returning to FIG. 6, the description will be continued.

The light quantity control mechanism 500 is held by a holding frame 302b such that the light quantity control mechanism 500 can move along the optical axis together with the back group lens unit 305 composed of the back group lens 302 and the back group lens holding frame 302a.

Next, an internal configuration of the digital camera 1, which is the first embodiment of the first image taking apparatus according to the invention, will be described.

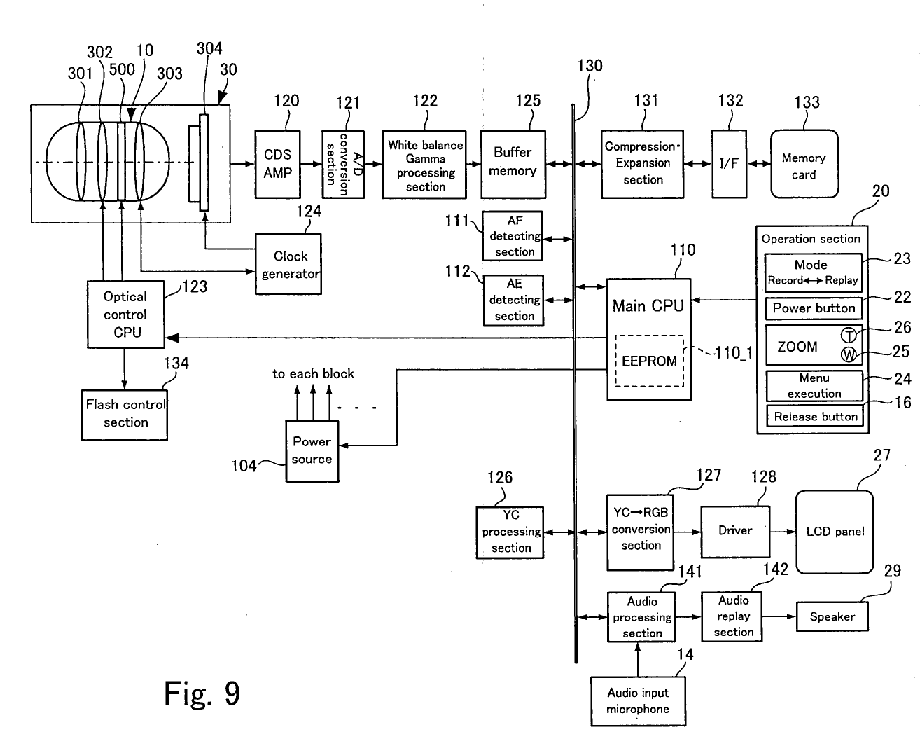

FIG. 9 is a diagram showing an internal configuration outline of the digital camera 1 shown in FIG. 2.

The digital camera 1 is provided with a main CPU 110, which controls all processes of the digital camera 1.

The main CPU 110 includes an EEPROM 110_1. The EEP ROM 110_1 is composed of rewritable nonvolatile memories. The main CPU 110 also includes a ROM, in which programs are stored. Operations of the digital camera 1 are controlled by the main CPU 110 in accordance with procedures of the programs.

The digital camera 1 includes an operation section 20 and a power supply 104. The operation section 20 gives the main CPU 110 instructions for processing responding to operations of operation members provided on the back 21 on the top 14 of the digital camera 1 described in FIGS. 2 and 4. The power supply 104 provides power to each block when the power is turned on.

The digital camera 1 includes an image taking section 30 constituting an image taking optical system. As described above, the image taking section 30 includes the lens barrel 10 and the CCD 304. The light quantity control mechanism 500 is provided in the lens barrel 10. Operations of the light quantity control mechanism 500 will be described later.

The digital camera 1 includes a CDS AMP 120, an A/D conversion section 121, a white balance/gamma processing section 122, an optical control CPU 123 and a clock generator 124. The CDS AMP 120 performs processes such as reducing noises of an analogue image signal output from the CCD 304. The A/D conversion section converts an analogue image signal to a digital image signal. The white balance/gamma processing section 122 adjusts white balance and performs a gamma correction for an object image responding to the instructions from the main CPU 110. The optical control CPU 123 extends the lens main barrel 10 and moves the shooting lens in the lens main body barrel 10 by controlling a motor (not shown) in accordance with the instruction from the main CPU 110. The clock generator 124 outputs a timing signal through the optical control CPU 123 in accordance with the instruction from the main CPU 110. In the CCD 304, the A/D conversion section 121 and the white balance/gamma processing section 122, an image signal is systematically processed synchronously with the timing signal output from the clock generator 124.

The digital camera 1 includes an AF detecting section 111 and an AE detecting section 112. The AF detecting section 111 detects focusing information on an image, and the AE detecting section 112 detects luminance information of an image.

The digital camera 1 includes a buffer memory 125, a YC processing section 126, a YC→RGB conversion section 127, a driver 128 and a data bus 130. The buffer memory 125 temporarily stores RGB image data processed in the white balance/gamma processing section 122. The YC processing section 126 converts an image signal input through the data bus 130 to a YC signal represented by luminance (Y) and color (C). Low-resolution through image data stored in the buffer memory 125 is supplied to the YC→RGB conversion section 127 through the bus 130 on a first-in-first-out basis. The through image data is in RGB form and is not processed in the YC→RGB conversion section 127. Accordingly, the through image data is transferred to the LCD panel 27 to be displayed through the driver 128 which quickly processes the through image data.

The digital camera 1 includes a compression and decompression section 131, an interface (I/F) section 132, a memory card 133 and a flash control section 134. The compression and decompression section 131 compresses image data converted to YC format data. The interface (I/F) section 132 provides communication interface complied with various communication standards to record compressed image data in the memory card 133. The flash control section 134 flashes through a flash window 12.

The digital camera 1 includes an audio processing section 141 and an audio replaying section 142. The audio processing section 141 converts sounds picked up with a microphone to audio data. The audio replaying section 142 replays appropriate audio data with a speaker 29.

Next, image-taking operation of the digital camera 1 will be described.

The description will show a case where a user takes a motion picture.

First, the user presses the power button 22 to perform a power-on operation, and then the operation section 20 accepts the operation. Accordingly, the main CPU 110 starts programs stored in the ROM to display an image on the LCD panel 27 and goes to a state to accept a setting operation for an image taking condition.

When the user selects a motion picture mode using the menu selection and execution key after turning the mode switch 23 to the motion picture mode, the main CPU 110 causes the CCD 304 at predetermined intervals to output image data representing an object image focused on the CCD 304, to the CDS AMP 120. The output image data is processed through the A/D conversion section and the subsequent processing sections to obtain a through image to be displayed on the LCD panel 27. Then, the object images captured by the shooting lens are displayed on the LCD panel 27 as if the images were a motion picture.

When the user designates a view angle using the wide-angle zoom key 25 or the telephoto zoom key 26 arranged on the back 21 of the digital camera 1, the designated view angle is passed on to the optical control CPU 110, and then to the optical control CPU 123. The optical control CPU 123 controls the motor and etc. (not shown), and extend the lens barrel 10 to move the back group lens 302 to a position corresponding to the view angle. In addition, the optical control CPU 123 controls the motor and etc. (not shown) to move the focusing lens 302 shown in FIGS. 5 to 7 along the optical axis.

The user takes an image on a through image displayed on the LCD panel 27. Therefore, the AF detecting section 111 continuously senses a focusing position and a focusing mechanism moves the focusing lens 303 to the focusing position such that a through image representing an object at which the user points the digital camera 1 is promptly displayed.

The user sets the image taking condition to recording start using the menu selection and execution key 24, then the AE detecting section 112 consequently detects luminance of field.

Receiving an instruction from the main CPU, the optical control CPU 123 causes electrodes of the first diaphragm blade 501a and the second diaphragm blade 501b to apply electrical field, based on the luminance of field. The first diaphragm blade 501a and the second diaphragm blade 501b expand and contract responding to the electrical field formed inside, and the electrodes adhered on the expansion and contraction layers 101_2 and 101_3 simultaneously expand and contract. As the first diaphragm blade 501b and the second diaphragm blade 501b expand, an area of an aperture overlaying the aperture 502a of the base plate varies. As a result, light quantity of the object is controlled most appropriately based on the luminance of field to adjust the diaphragm.

Subsequently, the image data representing the object focused on the CCD 304 is output at the predetermined intervals to the CDS AMP 120. The CDS AMP 120 reduces noises of the image data output from the CCD 304 and provides the noise reduced image data to the A/D conversion section 121. The A/D conversion section 121 generates image data composed of RGB digital signals converted from analogue signals. The generated image data is image-processed in the white balance/gamma processing section 122 and then is stored in the buffer memory 125. The image data stored in the buffer memory 125 is provided to the YC conversion section 126 to be converted to a YC signal from the RGB signal. The compression and decompression section 131 performs a compression process on the taken image data converted to the YC signal. Further, the main CPU 110 stores the motion picture data associated with the audio data both taken together in the memory card 133 through the I/F 132.

In addition, the motion picture data stored in the memory card 133 is expanded in the compression and decompression section 131 and is converted to a RGB signal in the YC/RGB conversion section 127 and then the motion picture data is transferred to the LCD panel 27 through the driver 128. A motion picture represented by the motion picture data is displayed on the LCD panel 27.

As the user sets an image taking condition to “the image taking finished” using the menu selection and execution key 24, recording a motion picture and sounds is finished.

In the description above, the light quantity control mechanism 500 is explained as a diaphragm controlling the aperture, and also performs well as a shutter which mechanically controls an area of the aperture and a shutter speed.

Next, a digital camera of a second embodiment of the first image taking apparatus will be described.

A difference of the digital camera between the second embodiment of the first image taking apparatus and the digital camera 1 will only be described. The difference lies in a configuration of the light quantity control mechanism.

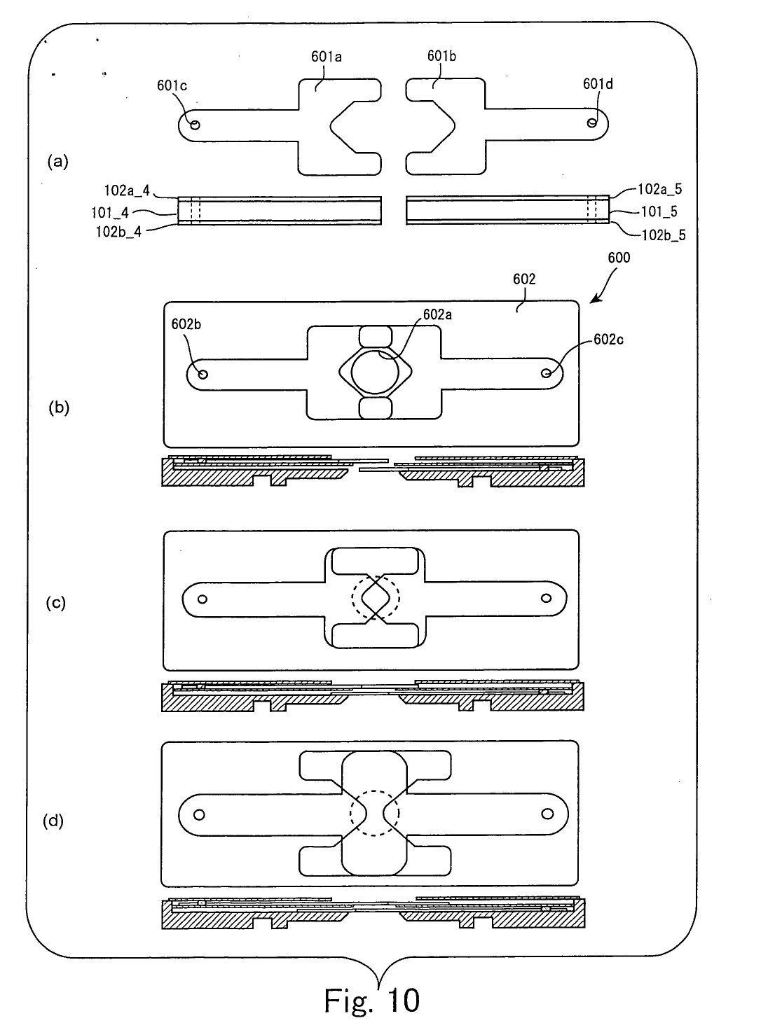

FIG. 10 is a diagram showing a light quantity control mechanism of the digital camera which is the second embodiment of the first image taking apparatus.

Part (a) of FIG. 10 is a diagram showing a configuration of a first diaphragm blade and a second diaphragm blade.

Part (b) of FIG. 10 shows a front view and a cross section of the light quantity control mechanism.

This light quantity control mechanism 600 includes a base plate 602 having an aperture, the first diaphragm blade 601a and the second diaphragm blade 601b. The first diaphragm blade 601a and the second diaphragm blade 601b are the light quantity control plate having shading quality described in FIG. 1.

The first diaphragm blade 601a is provided with electrodes 102a_4 and 102b_4 both sandwiching an expansion and contraction layer 101_4. The second diaphragm blade 601b is provided with electrodes 102a_5 and 102b_5 both sandwiching an expansion and contraction layer 101_5. Electrostrictive polymer is used in the expansion and contraction layers 101_{—}4 and 101_5. Thickness for each section of the first diaphragm blade 601a and the second diaphragm blade 601b appears large in the drawing for the sake of convenience, however, the thickness of the blades is practically thin as shown in part (b) of FIG. 10.

Both of the first diaphragm blade 601a and the second diaphragm blade 501b are located on the base plate 602. The first diaphragm blade 601a is provided with an aperture 601c and is pinned on the base plate 602 with a fixing pin member 602b. The second diaphragm blade 601b is provided with an aperture 601d and is pinned on the base plate 602 with fixing pin member 602c.

Part (b) of FIG. 10 is a diagram showing positions of the first diaphragm blade 601a and the second diaphragm blade 601b in an initial state.

The shapes of the diaphragm blades 601a and 601b are different from those of the diaphragm blades 501a and 501b shown in part (c) of FIG. 8 such that the aperture 602a of the base plate 602 is wholly open by the diaphragm blades 601a and 601b when the power is off. Accordingly, the electric power consumption is reduced when the diaphragm blades 601a and 601b are used as a shutter for reading image data of the CCD 304.

Part (c) of FIG. 10 shows the position relation between the first diaphragm blade 601a and the second diaphragm blade 601b after the power is turned on to apply a predetermined voltage.

The first diaphragm blade 601a and the second diaphragm blade 601b expand to vary an area of the aperture, which is formed by themselves, overlapping the aperture 602a of the base plate. In part (c) of FIG. 10, a portion of the aperture 602a of the base plate is overlapped with the first diaphragm blade 601a and the second diaphragm blade 601b.

Part (d) of FIG. 10 shows the position relation between the first diaphragm blade 601a and the second diaphragm blade 601b after a predetermined voltage is added further to the state shown in part (c) of FIG. 10.

The first diaphragm blade 601a and the second diaphragm blade 601b both expand responding to an applied voltage to close wholly the aperture 602a of the base plate.

As the light quantity control mechanism 600 applied in the second embodiment of the first image taking apparatus is used to replace the light quantity control mechanism 500 shown in FIGS. 6 to 8, a user may take a motion picture with noises reduced, similarly to the digital camera 1 described above.

Next, a light quantity control mechanism of a digital camera, which is a first embodiment of a second image taking apparatus, will be described.

Differences between the light quantity control mechanism of the second image taking apparatus and the light quantity control mechanism of the first image taking apparatus are described as follows. In the light quantity control mechanism of the first image taking apparatus, the light quantity control plate is configured to expand and contract responding to an applied voltage. On the other hand, in the light quantity control plate of the second image taking apparatus is configured not to expand and contract but to move to vary an area of an aperture overlapping an aperture of a base plate. In addition, a driving plate, which expands and contracts to move light quantity control plates responding to an applied voltage, is newly added.

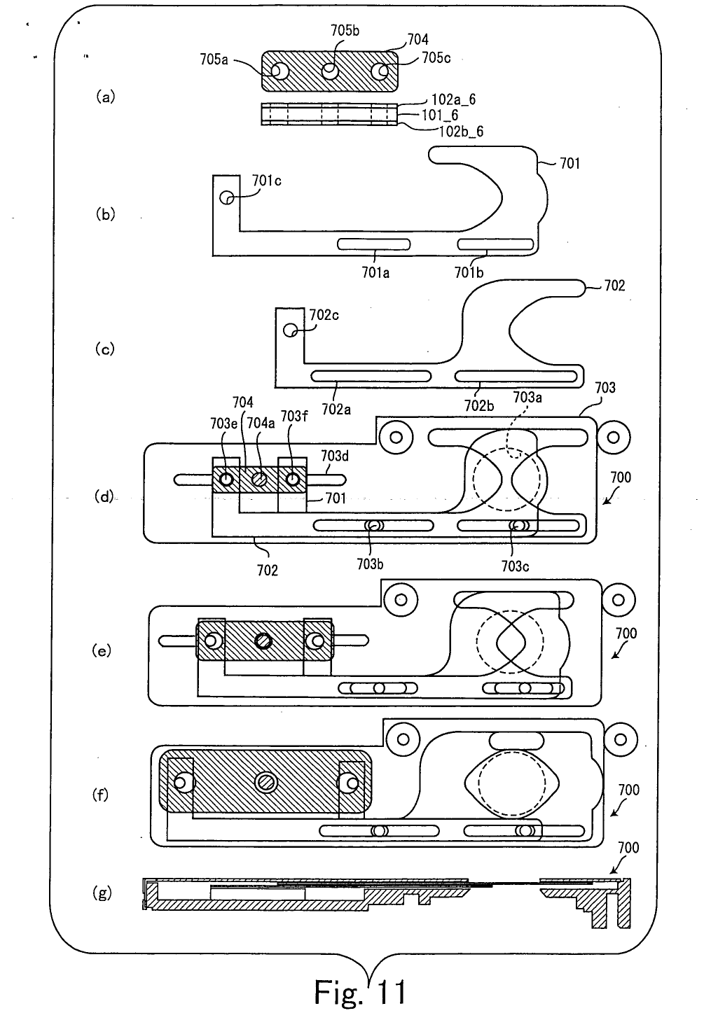

FIG. 11 is a diagram showing the light quantity control mechanism of the digital camera which is the first embodiment of the second image taking apparatus.

Part (a) of FIG. 11 is a diagram showing a configuration of the driving plate which expands and contracts, responding to an electrical field, to move the light quantity control plates.

Part (b) of FIG. 11 is a front view showing a first diaphragm blade as the light quantity control plate. Part (c) of FIG. 11 is a front view showing a second diaphragm blade as the light quantity control plate.

Based on the same principle described using FIG. 1, a driving plate 704 shown in part (a) of FIG. 11 expands and contracts responding to an electrical field formed by an applied voltage. The driving blade 704 has shading quality and is provided with electrodes 102a_6 and 102b_6 both sandwiching an elastic layer 101_6 which expands and contracts responding to an electrical field. In addition, the driving plate 704 includes apertures 705a, 705b and 705c. These apertures will be described later.

Electrostrictive polymer is used in the elastic layer 101_6.

The electrodes 102a_6 and 102b6 are made of an expanding and contracting polymer and are adhered to the elastic layer 101_{—}6 to expand and contract together with the elastic layer 101_6.

The thickness of the section of the driving plate 704 appears large in the drawing for the sake of convenience, however, the driving plate 704 is practically made thin.

The first diaphragm blade 701 is provided with guide apertures 701a, 701b and 701c for moving on the base plate 701. The second diaphragm blade 702 is also provided with guide apertures 702a, 702b and 702c for moving on the base plate 701.

Part (d) of FIG. 11 shows a front view of the light quantity control mechanism 700.

The first diaphragm blade 701 and the second diaphragm blade 702 are arranged such that they are overlapping with each other on the base plate 703.

A first pin 703e goes through an aperture 705a of the driving plate 704 and the guide aperture 702c of the first diaphragm blade 702. A second pin 703f goes through an aperture 705c of the driving plate 704 and the guide aperture 701c of the second diaphragm blade 701. The first pin 703e and the second pin 703f slide on a driving plate guide groove 703d formed on the base plate 703.

The driving plate 704 is pinned with a third pin 704a through an aperture 705b on the base plate 703. A fourth pin 703b goes through the guide apertures 701a and 702a, and a fifth pin 703c goes through the guide apertures 701b and 702b.

Part (d) of FIG. 11 is a diagram showing the position relation between the first diaphragm blade 701 and the second diaphragm blade 702 after a predetermined voltage is applied with the power on.

The first diaphragm blade 701 and the second diaphragm blade 702 expand with a voltage applied, to vary an area of the aperture overlapping the aperture 703a of the base plate. In part (d) of FIG. 11, a portion of the aperture 703a of the base plate is covered by the first diaphragm blade 701 and the second diaphragm blade 702.

Part (e) of FIG. 11 shows the position relation between the first diaphragm blade 701 and the second diaphragm blade 702 after a predetermined voltage is added further to the state shown in part (d) of FIG. 11.

The first diaphragm blade 701 and the second diaphragm blade 702 both expand with a voltage applied to uncover wholly the aperture 703a of the base plate. Part (g) of FIG. 11 shows a cross section of the drawing shown in part (f) of FIG. 11.

As the light quantity control mechanism 700 applied in the first embodiment of the second image taking apparatus is used to replace the light quantity control mechanism 500 shown in FIGS. 6 to 8, a user may take a motion picture with noises reduced, similarly to the digital camera described above.

Next, a light quantity control mechanism of a digital camera, which is a second embodiment of the second image taking apparatus, will be described.

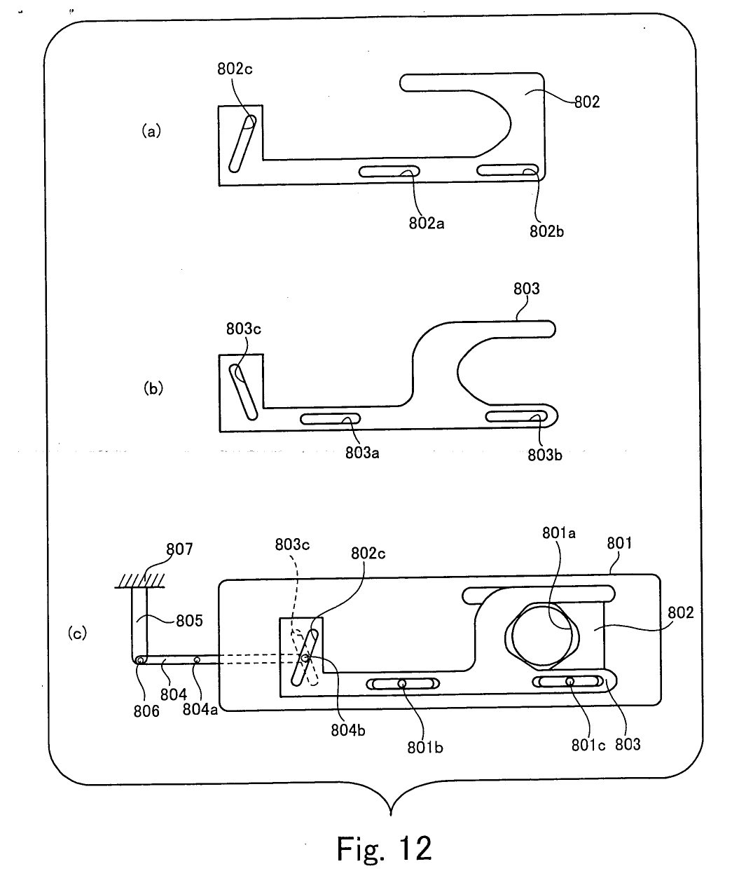

FIG. 12 is a diagram showing a light quantity control mechanism of a digital camera which is the second embodiment of the second image taking apparatus.

Part (a) of FIG. 12 is a front view showing a first diaphragm blade 802.

The first diaphragm blade 802 includes guide apertures 802a, 802b and 802c for sliding on a baseplate 801 by expansion and contraction of the driving plate 805. The driving plate 805 will be described later.

Part (b) of FIG. 12 is a front view showing the second diaphragm blade 803. The second diaphragm blade 803 includes guide apertures 803a, 803b and 803c for sliding on the base plate 801 by expansion and contraction of the driving plate 805.

Part (c) of FIG. 12 is a front view showing the light quantity mechanism 800.

The first diaphragm blade 802 and the second diaphragm blade 803 are arranged such that they are overlapping with each other on the base plate 801. The guide aperture 802a of the first diaphragm blade 802 and the guide aperture 803a of the second diaphragm blade 803 are overlapped each other such that a guide pin 801b goes through these apertures on the base plate 801. The guide aperture 802b of the first diaphragm blade 802 and the guide aperture 803b of the second diaphragm blade 803 are overlapped each other such that a guide pin 801c goes through these apertures on the base plate 801.

One end of the driving plate 805 of the light quantity control mechanism 800 is fixed to a part 807 of the digital camera main body. The driving plate 805 expands and contracts responding to an electrical field formed by an applied voltage, similarly to the driving plate 704.

An end of a guide member 804 for sliding the diaphragm blade is connected through a guide pin 806 to a tip of the driving plate 805. A guide pin 804b goes through the guide aperture 801c of the first diaphragm blade 802, the guide aperture 802c of the second diaphragm blade 803 and the base plate 801 to be connected to the other end of the guide member 804. The guide member 804 is rotationally supported by a rotation axis 804a.

As the driving plate 805 expands with a voltage applied, the guide member rotates counterclockwise about the rotation axis 804a. As a result, the first diaphragm blade 802 and the second diaphragm blade 803 slide in different directions each other, covering the aperture 801a of the base plate 801. Accordingly, an area of the aperture 801a of the base plate can be varied by applying variably a voltage to the driving plate 805.

As the light quantity control mechanism 800 applied in the second embodiment of the second image taking apparatus is used to replace the light quantity control mechanism 500 shown in FIGS. 6 to 8, a user may take a motion picture with noises reduced, similarly to the digital camera 1 described above.

Next, a light quantity control mechanism of a digital camera, which is a third embodiment of the second image taking apparatus, will be described.

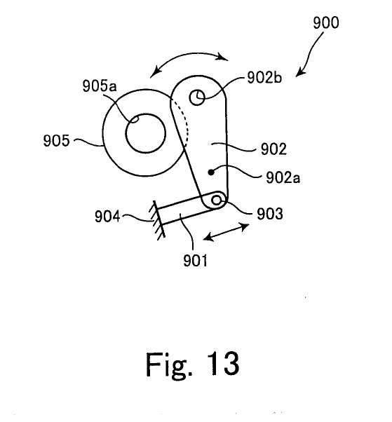

FIG. 13 is a diagram showing a light quantity control mechanism of a digital camera which is the third embodiment of the second image taking apparatus.

In the light quantity control mechanism 900, a driving plate 901 is attached to a part 904 of a digital camera. The driving plate 901 expands and contracts responding to an electrical field formed by an applied voltage, similarly to the driving plate 704. A light quantity control plate 902, which varies an area covering an aperture 905a of a base plate 905, is connected to the driving plate 901 at a connecting section 903. The light quantity control plate 902 is provided with an aperture 902a smaller than the aperture 905a. The light quantity control plate 902 is rotationally supported by a rotation axis 902a. The light quantity control plate 902 is a diaphragm member driven by the driving plate 901 to move between a small aperture position where the aperture 902b overlaps with the aperture 905a of the base plate and a saved position where the light quantity control plate 902 is saved from the aperture 905a of the base plate.

The base plate 905 is arranged such that the aperture 905a is set on an optical axis of an image taking optical system. As the light quantity control mechanism 900 applied in the third embodiment of the second image taking apparatus is used to replace the light quantity control mechanism 500 shown in FIGS. 6 to 8, a user may take a motion picture with noises reduced, similarly to the digital camera 1.

An electrostrictive polymer is used for the expansion and contraction layer of the light quantity control plate applied in the embodiments of the first image taking apparatus and the expansion and contraction layers of the driving plates applied in the embodiments of the second image taking apparatus. However, an liquid crystal elastomer which expands and contracts responding to an electrical field may be used to obtain same results.

As described above, according to the invention, an image taking apparatus which is miniaturized and includes a mechanism to control light quantity with noises reduced can be obtained.

In the embodiments, an electrostrictive polymer or a liquid crystal elastomer are exemplified as the expansion and contraction layer. However, polymers such as a polymer gel, an ionic conductive polymer and a piezo polymer may be used as a polymer which expands and contracts responding to an electrical field.

What is claimed is:

1. An image taking apparatus that includes an imaging device reading an object image formed on an imaging area to generate image data and an image taking optical system imaging an object on the imaging area, and generates image data responding to an image taking operation, the image taking apparatus comprising:
a light quantity control mechanism that regulates quantity of object light to transmit to the imaging area, the object light entering into the image taking optical system,
the light quantity control mechanism further comprising:
a base plate that has an aperture on an optical axis of the image taking optical system; and
a light quantity control plate that is arranged to overlap the base plate, and that expands and contracts responding to an electrical field formed by an applied voltage, thereby varying an area covering the aperture of the base plate.

2. The image taking apparatus according to claim 1, wherein the light quantity control plate is composed of a plurality of diaphragm blades that jointly form an aperture overlapping the aperture of the base plate, and that expand and contract responding to an electrical field, thereby varying an area of the aperture overlapping the aperture of the base plate.

3. The image taking apparatus according to claim 1, the light quantity control plate further comprising:
a member made of a liquid crystal elastomer that expands and contracts responding to an electrical field; and
a pair of electrodes that are arranged to sandwich the member made of the liquid crystal elastomer, and that form an electrical field in the member made of the liquid crystal elastomer with a voltage applied, thereby expanding and contracting the member made of the liquid crystal elastomer.

4. The image taking apparatus according to claim 1, the light quantity control plates further comprising:
a member made of an electrostrictive polymer that expands and contracts responding to an electrical field; and
a pair of electrodes that are arranged to sandwich the member made of the electrostrictive polymer, and that form an electrical field in the member made of the electrostrictive polymer with a voltage applied, thereby expanding and contracting the member made of the electrosrictive polymer.

5. An image taking apparatus that includes an imaging device reading an object image formed on an imaging area to generate image data and an image taking optical system imaging an object on the imaging area, and generates image data responding to an image taking operation, the image taking apparatus comprising:
a light quantity control mechanism that regulates quantity of object light to transmit to the imaging area, the object light entering into the image taking optical system, wherein
the light quantity control mechanism further comprising:
a base plate that has an aperture on an optical axis of the image taking optical system;
a light quantity control plate that moves to vary an area covering the aperture of the base plate; and
a driving plate that expands and contracts responding to an electrical field formed by an applied voltage, thereby moving the light quantity control plate.

6. The image taking apparatus according to claim 5, wherein the light quantity control plate is a diaphragm member that has an aperture and is driven by the driving plate to move between a small aperture position where the aperture overlaps the aperture of the base plate and a saved position where the light quantity control plate is saved from the aperture of the base plate.

7. The image taking apparatus according to claim 5, wherein the light quantity control plate is a diaphragm member that is arranged to overlap the base plate and that is driven by the driving plate, thereby moving to vary an area covering the aperture of the base plate.

8. The image taking apparatus according to claim 5, wherein the light quantity control plate is composed of a plurality of diaphragm blades that jointly form an aperture overlapping the aperture of the base plate, and that is driven by the driving plate, thereby varying an area of the aperture overlapping the aperture of the base plate.

9. The image taking apparatus according to claim 5, wherein the driving plate further comprising:
a member made of a liquid crystal elastomer that expands and contracts responding to an electrical field; and
a pair of electrodes that are arranged to sandwich the member made of the liquid crystal elastomer, and that form an electrical field in the member made of the liquid crystal elastomer with a voltage applied, thereby expanding and contracting the member made of the liquid crystal elastomer.

10. The image taking apparatus according to claim 5, wherein the driving plate further comprising:
a member made of an electrostrictive polymer that expands and contracts responding to an electrical field, and that form an electrical field in the member made of the electrostrictive polymer with a voltage applied, thereby expanding and contracting the member made of the electrostrictive polymer.
